(19) United States
(12) Patent Application Publication
(10) Pub. No.: US 2020/0307554 A1
(43) Pub. Date: Oct. 1, 2020

(54) SYSTEMS AND METHODS FOR PARKING A VEHICLE

(71) Applicant: Denso International America, Inc., Southfield, MI (US)

(72) Inventors: Ting-Yu Lai, Ann Arbor, MI (US); Andrew Mueller, Farmington Hills, MI (US)

(21) Appl. No.: 16/365,068

(22) Filed: Mar. 26, 2019

(51) Int. Cl. B60W 30/06; G06K 9/00; G08G 1/14

(52) U.S. Cl. CPC B60W 30/06; G08G 1/143; G06K 9/00818; G06K 9/00812

(57) ABSTRACT

Systems, methods, and other embodiments described herein relate to auto-parking a vehicle in accordance with user preferences. In one embodiment, a disclosed system identifies an available parking space and one or more attributes of the available parking space based, at least in part, on information from one or more sensors. The system classifies the available parking space as a target parking space based, at least in part, on the one or more attributes satisfying a preference threshold defined according to one or more user-defined criteria that indicate characteristics of the target parking space. The system generates parking instructions configured to cause the subject vehicle to park in the target parking space.

### TECHNICAL FIELD

The subject matter described herein relates to systems and methods for parking a vehicle, and, more particularly, to parking an autonomous or semi-autonomous vehicle according to user preferences.

### BACKGROUND

Parking a vehicle can be a time-consuming and frustrating task. While multiple parking spaces may be available at a venue, some parking spaces may satisfy a driver's preferences more than others, but the driver is not able to ascertain as much without spending time driving around the venue to investigate. Moreover, when a driver arrives at a venue, relatively few parking available spaces may be scattered widely across a parking zone. If the driver does not have time to search for a preferable parking space, the driver may be forced to take the first available parking space even if it is not preferable.

While autonomous vehicles are becoming more prevalent, they generally operate to travel from a starting location to a destination where the vehicle simply stops or parks in a predefined zone. Thus, the predefined zones or other parking location of an autonomous vehicle may not satisfy the preferences of the passenger or the vehicle may even be unable to park when such zones are unavailable, thereby causing difficulties with the use and overall experience associated with the autonomous vehicle.

### SUMMARY

In one embodiment, example systems and methods associated with auto-parking a vehicle are disclosed. In various situations, such as when multiple parking spaces may be available but it is not readily apparent to a driver where a parking space that the driver would prefer is located, or when it appears that no parking spaces is immediately available and extended effort would be required to find a parking space that the driver would prefer, an autonomous or semi-autonomous vehicle can operate to autonomously park within a search zone. Using various types of sensors and communication devices, the vehicle can identify and prioritize parking spaces to locate and park in a parking space that matches a user's preference, if possible. Accordingly, the user can exit the vehicle and proceed to their desired destination while the vehicle autonomously locates and parks in the parking space, thereby saving the user time.

Therefore, a vehicle control system for a subject vehicle is disclosed. For example, in one approach the disclosed system communicates with one or more sensors that output information describing an environment around the subject vehicle. The system includes one or more processors and a memory communicably connected to the one or more processors and storing a selection module and parking module. The selection module includes one or more instructions that, when executed by the one or more processors, cause the one or more processors to identify an available parking space and one or more attributes of the available parking space based, at least in part, on the information from the one or more sensors, and classify the available parking space as a target parking space based, at least in part, on the one or more attributes satisfying a preference threshold defined according to one or more user-defined criteria that indicate characteristics of the target parking space. The parking module includes one or more instructions that, when executed by the one or more processors, cause the one or more processors to generate parking instructions configured to cause the subject vehicle to park in the target parking space.

In another approach, the disclosed system identifies an available parking space and one or more attributes of the available parking space based, at least in part, on information from one or more sensors, classifies the available parking space as a target parking space based, at least in part, on the one or more attributes satisfying a preference threshold defined according to one or more user-defined criteria that indicate characteristics of the target parking space, and generates parking instructions configured to cause the subject vehicle to park in the target parking space.

In one embodiment, a non-transitory computer-readable medium is disclosed. The computer-readable medium stores instructions that when executed by one or more processors cause the one or more processors to perform the disclosed functions. The instructions include instructions to identify an available parking space and one or more attributes of the available parking space based, at least in part, on information from one or more sensors, classify the available parking space as a target parking space based, at least in part, on the one or more attributes satisfying a preference threshold defined according to one or more user-defined criteria that indicate characteristics of the target parking space, and generate parking instructions configured to cause the subject vehicle to park in the target parking space.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle control system according to the disclosed subject matter.

FIG. 2 illustrates an example parking environment in which a vehicle control system according to the disclosed subject matter may operate.

FIG. 3 illustrates an example user interface according to the disclosed subject matter.

FIGS. 4A and 4B illustrate an example flowchart of operations of a vehicle control system according to the disclosed subject matter.

### DETAILED DESCRIPTION

Systems, methods and embodiments associated with improving autonomously locating a parking space and parking therein are disclosed. A user may desire that his/her vehicle be parked in a parking space that matches certain criteria. For example, a user may desire an electric vehicle be parked near a charging station, or a user may desire a space that is covered or near a particular entrance to a mall. Typically, if a user desires a parking space with particular attributes, the user must spend time driving around the parking area, manually searching for the parking space.

In contrast, in various embodiments, a vehicle control system and associated methods are disclosed herein to search for and identify an available parking space that has one or more attributes that a user desires, and to further control the subject vehicle to autonomously park in the parking space, freeing the user to immediately attend to the subject matter of the user's visit.

The vehicle control system, in one or more embodiments, searches for and identifies an available parking space. As used herein, “available parking space” refers to a parking space that is currently unoccupied. Although unoccupied, a subject vehicle is not necessarily free to park in all available parking spaces. As will be discussed below, various rules or regulations may prohibit parking in an available parking space.

In one or more embodiments, the disclosed vehicle control system identifies one or more attributes of an available parking space. As used herein, “attributes” refers to one or more of: 1) physical characteristics of a parking space (e.g., width, length, in shade, covered, uncovered, space between parking lines and a nearest parked car, etc.); 2) contextual characteristics of the parking space (e.g., proximity to an entrance, proximity to a specific object such as charge station or cart return station, etc.); and 3) regulatory characteristics of the parking space (e.g., a regulatory status of a space, such as handicap parking or reserved space or visitor space, cost to park in the space, etc.).

Generally, the disclosed vehicle control system can identify an available parking space and attributes of the space, for example, based on: 1) retrieving metadata about the parking space according to a current location of the subject vehicle; 2) using one or more machine perception components to analyze sensor data and identify signs proximate to the parking space, characteristics of the surrounding environment, and/or markings on a surface of the parking space; 3) communicating with a parking facility system to retrieve the attributes.

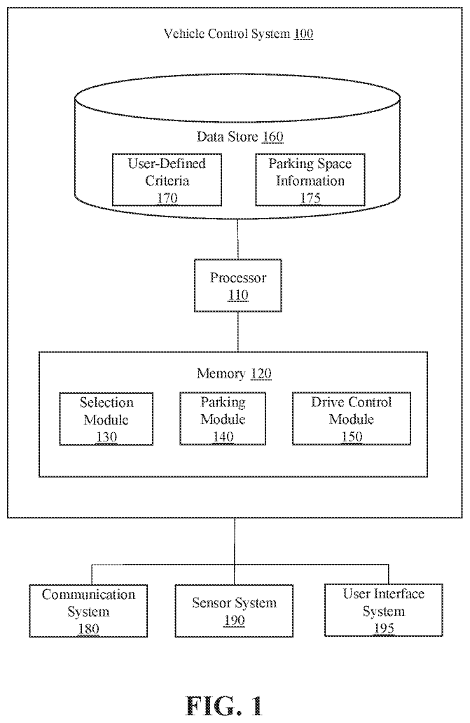

Referring to FIG. 1, one embodiment of a vehicle control system 100 is illustrated. While arrangements will be described herein with respect to the vehicle control system 100, it will be understood that embodiments are not limited to a unitary system as illustrated. In some implementations, the vehicle control system 100 may be embodied as a cloud-computing system, a cluster-computing system, a distributed computing system, a software-as-a-service (SaaS) system, and so on. Accordingly, the vehicle control system 100 is illustrated and discussed as a single device for purposes of discussion but should not be interpreted to limit the overall possible configurations in which the disclosed components may be configured. For example, the separate modules, memories, databases, and so on may be distributed among various computing systems in varying combinations.

The vehicle control system 100 also includes various elements. It will be understood that in various embodiments it may not be necessary for the vehicle control system 100 to have all of the elements shown in FIG. 1. The vehicle control system 100 can have any combination of the various elements shown in FIG. 1. Further, the vehicle control system 100 can have additional elements to those shown in FIG. 1. In some arrangements, the vehicle control system 100 may be implemented without one or more of the elements shown in FIG. 1. Further, while the various elements are shown as being located within the vehicle control system 100 in FIG. 1, it will be understood that one or more of these elements can be located external to the vehicle control system 100. Further, the elements shown may be physically separated by large distances.

Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

In either case, the vehicle control system 100 is implemented to perform methods and other functions as disclosed herein relating to autonomously parking a vehicle. The noted functions and methods will become more apparent with a further discussion of the figures. Furthermore, the vehicle control system 100 is shown as including a processor 110. Thus, in various implementations, the processor 110 may be a part of the vehicle control system 100, the vehicle control system 100 may access the processor 110 through a data bus or another communication pathway, the processor 110 may be a remote computing resource accessible by the vehicle control system 100, and so on. In either case, the processor 110 is an electronic device such as a microprocessor, an ASIC, or another computing component that is capable of executing machine-readable instructions to produce various electronic outputs therefrom that may be used to control or cause the control of other electronic devices.

In one embodiment, the vehicle control system 100 includes a memory 120 that stores, among other things, a selection module 130, a parking module 140 and a drive control module 150. The memory 120 is a random-access memory (RAM), read-only memory (ROM), a hard-disk drive, a flash memory, or other suitable memory for storing the modules 130, 140 and 150. The modules 130, 140 and 150 are, for example, computer-readable instructions that when executed by the processor 110 cause the processor 110 to perform the various functions disclosed herein. In various embodiments, the modules 130, 140 and 150 can be implemented in different forms that can include but are not limited to hardware logic, an ASIC, components of the processor 110, instructions embedded within an electronic memory, and so on.

With continued reference to the vehicle control system 100, in one embodiment, the vehicle control system 100 includes a data store 160 that can be implemented as and will be referred to as a database 160. The database 160 is, in one embodiment, an electronic data structure stored in the memory 120, a distributed memory, a cloud-based memory, or another data store and that is configured with routines that can be executed by the processor 110 for analyzing stored data, providing stored data, organizing stored data, and so on. Thus, in one embodiment, the database 160 stores data used by the modules 130, 140 and 150 in executing various determinations, such as user-defined criteria 170, which indicates characteristics of a parking space that a user prefers, and parking space information 175, which indicates gathered information about parking spaces.

The vehicle control system 100 can be communicably connected to other systems and components of the subject vehicle, such as a communication system 180, a sensor system 190, and a user interface system 195. The modules 130, 140, and 150 of the vehicle control system 100 can communicate with and receive data from such systems.

In one embodiment, the selection module 130 includes instructions that cause the processor 110 to identify an available parking space and attributes of the available parking space. The selection module 130 can identify the parking space based on, for example, image recognition techniques applied to data obtained from the sensor system 190 or from data forwarded from the communication system 180. The selection module 130 can further determine whether the available parking space is a target parking space (i.e., a space that a subject vehicle should park in), a potential parking space (i.e., a space that subject vehicle may park in), or a prohibited parking space (i.e., a space that the subject vehicle cannot park in) based on various factors, such as user-defined criteria 170 received via a user interface system 195, as will be discussed further below.

In one embodiment, the parking module 140 includes instructions that cause the processor 110 to control the vehicle to attempt to park in a space that the selection module 130 has classified as a target parking space. The parking module 140 can also control a “parking countdown” which can trigger the parking module to cause the processor 110 to control the vehicle to attempt to park in a space that the selection module 130 has classified as a potential parking space when no target parking space has been located by the expiration of the parking countdown.

In one embodiment, the drive control module 150 includes instructions that cause the processor 110 to navigate the subject vehicle within a given search zone to search for available parking spaces when no target parking space has yet been identified. The drive control module 150 can also control a “search countdown.” The search countdown can trigger the drive control module 150 to change the search zone or navigate the subject vehicle to a different search zone to search for available parking spaces when certain conditions are met.

As previously mentioned, the vehicle control system 100 can communicate with and receive data from a communication system 180, a sensor system 190, and a user interface system 195. The communication system 180 can be configured to communicate, for example, over a local area network, a wide area network, directly with another system via an established protocol such as vehicle-to-everything (V2X), vehicle-to-vehicle (V2V), or through other communications methods. The sensor system 190 can include a global positioning system (GPS) receiver that can provide location information about the subject vehicle and one or more sensors, for example, a radar, camera, LIDAR, thermal sensor, ultrasonic sensor and/or other types of sensors that can provide information about an environment around the subject vehicle. The user interface system 195 can be implemented as part of an interface installed in the subject vehicle, for example, including a touch screen, scroll wheel, keypad or other type of input device that can receive input data from a user, and a display device that can display output data. The user interface system 195 can alternatively be implemented in other forms, for example, as an application installed on a user device that is in electronic communication with the vehicle control system 100.

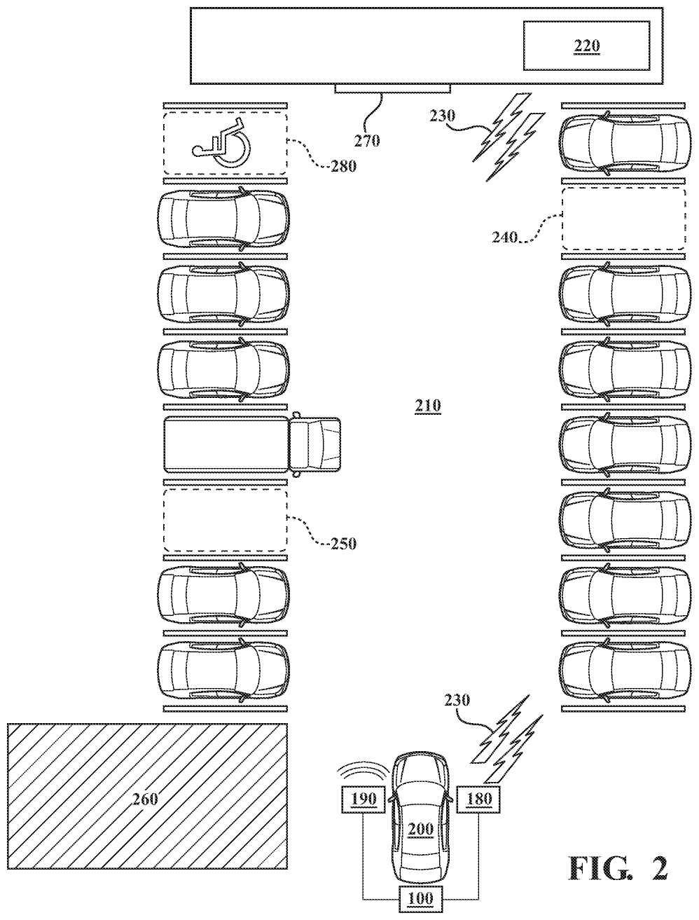

Details of operation of the disclosed vehicle control system 100 will now be discussed with reference to FIG. 2, which shows a subject vehicle 200 at a parking area 210. The parking area 210 is in front of a store entrance 270 and includes available parking spaces 240, 250, a shopping cart return station 260, and a handicap parking space 280. The subject vehicle 200 includes the vehicle control system 100, communication system 180 and sensor system 190, as discussed above. In this example, the user has already exited the subject vehicle 200 at a desired location and the subject vehicle 200 is currently in the process of autonomously parking.

The parking area 210 also includes a parking facility control system 220. The parking facility control system 220 may use a communication protocol, such as V2X or a different communication protocol, to transmit data 230 identifying locations of available parking spaces 240, 250 within the facility. The communication system 180 may receive the data 230 and transmit the information contained therein to the vehicle control system 100.

However, many parking areas may not include a parking facility control system 220. Accordingly, the sensor system 190 can directly detect information about the parking area 210 and transmit the information to the vehicle control system 100. For example, the sensor system 190 can include cameras, LIDAR, or other sensors as described above that can generate data indicating information about the parking area 210. Such data can include data indicating the detection/location of landmark features (e.g., shopping cart return station 260, store entrance 270, etc.), the detection/location of available parking spaces (e.g., spaces 240, 250), attributes of the available parking spaces (e.g., size, characteristics of adjacently parked vehicles, proximity to landmark features, etc.), and the presence of regulatory indicators (e.g., no-parking signs, reserved parking signs, handicap parking marker, etc.). In any case, by receiving information from one or more of an outside source or direct detection using one or more sensors, the vehicle control system 100 can detect and identify available parking spaces within a vicinity of the subject vehicle and attributes of the available parking spaces.

Referring to FIGS. 1 and 2, the selection module 130 of the vehicle control system 100 can include instructions to classify a detected available parking space (e.g., 240, 250) as a target parking space when there are no regulatory prohibitions attached to the available parking space and the available parking space satisfies one or more thresholds, referred to herein as the “preference threshold” and the “baseline threshold,” which are based on user-defined criteria 170. The user-defined criteria 170, which can be received via the user interface system 195, indicates one or more attributes or characteristics of a parking space that the user of the subject vehicle 200 prefers, and thereby serves as the basis for defining a target parking space for the subject vehicle 200.

Without limitation, user-defined criteria 170 can include one or more of: a preferred type of parking area, a preferred type of parking space, a designated object or location to park near, a designated object or location to avoid parking near, a maximum parking price amount, a preferred spacing around a parking space, a preferred parking space size, or other type of characteristic. Other types of user-defined criteria 170 are possible. For example, in one implementation the user-defined criteria 170 can specify that the user of subject vehicle 200 prefers parking near a shopping cart return station 260 and prefers not to park adjacent to large trucks. In this case, the optimal target parking space for the subject vehicle 200 is defined as an available parking space near a shopping cart return station 260 and not adjacent to a large truck.

The user-defined criteria 170 can further include a priority rating or weight values for individual criterion. Continuing the example above, in one or more embodiments, the user can rank the criteria 170 in order of priority, e.g.: 1) not adjacent to a large vehicle, 2) near a shopping cart return station 260. In other embodiments, the user can enter priority ratings directly for individual criterion.

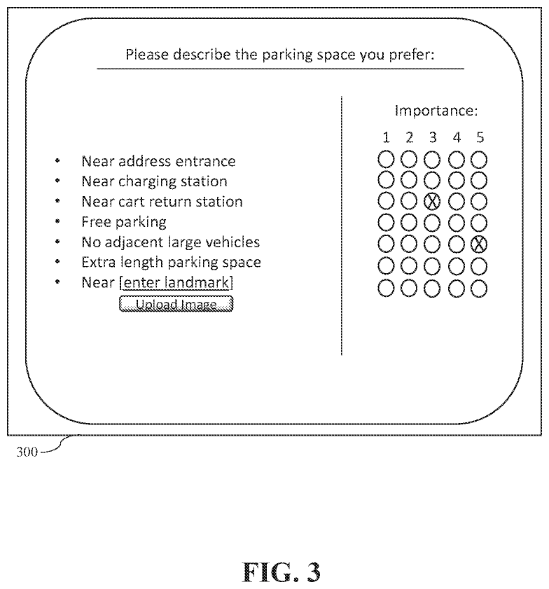

FIG. 3 shows an example interface 300 that the user interface system 195 can display for a user to select and prioritize the user-defined criteria 170. The listing of attributes shown is merely an example, as the disclosed embodiments are not limited to the attributes shown in the figure. Different attributes may be presented in different orders or in different formats. In the implementation shown in FIG. 3, the user can prioritize user-defined criteria 170 by directly rating selected criteria for importance, for example, on a scale of one-to-five. The user in the above-described example can set the user-defined criteria 170 to indicate that a target parking space not adjacent to a large vehicle is a “5” in importance, e.g., due to the user having a fear of large vehicles taking up too much space and increasing the risk of door dings, while the user rates a parking space near the shopping cart return station 260 as a “3” in importance.

Based on the user-defined criteria 170, the selection module 130 can set the baseline threshold and the preference threshold and determine whether or to what degree available parking spaces 240, 250 meets either threshold. The selection module 130 can compare the attributes of the available parking space against the user-defined criteria 170 to determine whether enough of the attributes correspond to user-defined criteria 170 to meet the preference threshold or baseline threshold. For example, in one or more embodiments the selection module 130 can determine a score for an available parking space and compare the score against the thresholds. The score can be determined based on values assigned to the user-defined criteria 170. The values can be weighted in accordance with a priority rating of the user-defined criteria 170. That is, attributes for a given space that correspond to the user-defined criteria 170 are given the corresponding weighted value and the sum total amount of the values for the attributes determines the score for the given space.

In an implementation, based on the example user-defined criteria 170 described above from FIG. 3, the selection module 130 could assign a value of “50” to the attribute “no adjacent large vehicle,” and a value of “30” to the attribute “near a shopping cart return station.” In evaluating the available parking spaces 240, 250, the selection module 130 would assign a score of “50” to parking space 240, since it satisfies the criterion of “no adjacent large vehicle” but not the criterion of “near a shopping cart return station,” and assign a score of “30” to parking space 250 since it satisfies the criterion of “near a shopping cart return station” but not the criterion of “no adjacent large vehicle.”

As previously discussed, the selection module 130 can set the preference threshold and the baseline threshold value based on the priority rating of the user-defined criteria 170. In one or more embodiments the selection module 130 can set a default preference threshold at a value equal to the score of the most preferred criterion among the user-defined criteria 170 and set a default baseline threshold at a value equal to the score of the least preferred criteria. Continuing the implementation discussed above, the selection module 130 can set the preference threshold equal to “50” and the baseline threshold equal to “30.” Alternatively, where a lower score corresponds with a better match, the thresholds may be defined inversely. Accordingly, in the example scenario shown in FIG. 2, the selection module 130 would determine that parking space 250 meets the baseline threshold and classify the space as a potential parking space. However, the selection module 130 would determine that the parking space 240 meets the preference threshold and classify the space as a target space.

The user can adjust the preference threshold and the baseline threshold, for example via the user interface system 195, to reflect the user's tolerance level for meeting preferences. For example, the user can scale the threshold values (e.g., closer adherence to specified preferences) to improve adherence to more preferences or scale the threshold values to relax adherence to preferences. For example, in one implementation the user can set the baseline threshold to a zero value.

In one or more embodiments, rather than prioritizing criteria the user can simply select the criteria that the user prefers. In this case, the selection module 130 can determine that an available parking space satisfies the preference threshold when a first percentage (e.g. 100%, 90%) of the user-defined criteria 170 are present in the attributes of the available parking space, and determine that the baseline threshold is satisfied when a second percentage (e.g. 25%, 15%) of the user defined criteria 170 are present in the attributes of the available parking space.

The difference between a potential parking space and a target parking space relates to the timing of when the parking module 140 will generate a parking instruction to cause the subject vehicle 200 to attempt to park in the space. When the selection module 130 classifies an available parking space as a target parking space, the parking module 140 will immediately generate a parking instruction to cause the subject vehicle 200 to attempt to park in the target parking space. However, if the selection module 130 classifies an available parking space as a potential parking space, the selection module 130 stores information regarding the potential parking space (e.g., the score, the location) in the database 160 as parking space information 175, and the parking module 140 will initiate a “parking countdown” while the subject vehicle 200 continues to search. When the parking countdown expires, if no target parking space has been located the parking module 140 will generate a parking instruction to cause the subject vehicle 200 to attempt to park in the potential parking space.

An effect of the parking countdown can be seen with reference to FIG. 2. The subject vehicle 200 first encounters the available parking space 240. Following the example discussed above, the selection module 130 classifies the space 240 as a potential parking space, triggering the initiation of the parking countdown by the parking module 140. During the parking countdown the drive control module 150 controls the subject vehicle to continue to autonomously navigate throughout the “search zone.” (As will be discussed further below, the search zone refers to a designated area that the vehicle control system 100 will keep the subject vehicle within for a designated amount of time while no parking instruction has been generated.)

The subject vehicle will, therefore, bypass parking space 250 and next encounter available parking space 240. The selection module 130, in one approach, classifies parking space 240 as a target parking space, triggering the immediate generation of parking instructions by the parking module 140. Once the subject vehicle 200 has successfully parked, the parking module 140 can nullify the parking countdown and the operation of the vehicle control system 100 is complete. However, if the parking operation was unsuccessful, for example, due to an obstacle preventing the subject vehicle from completing the maneuver or another vehicle entered the space first, then the parking countdown will continue as the subject vehicle 200 continues to autonomously search.

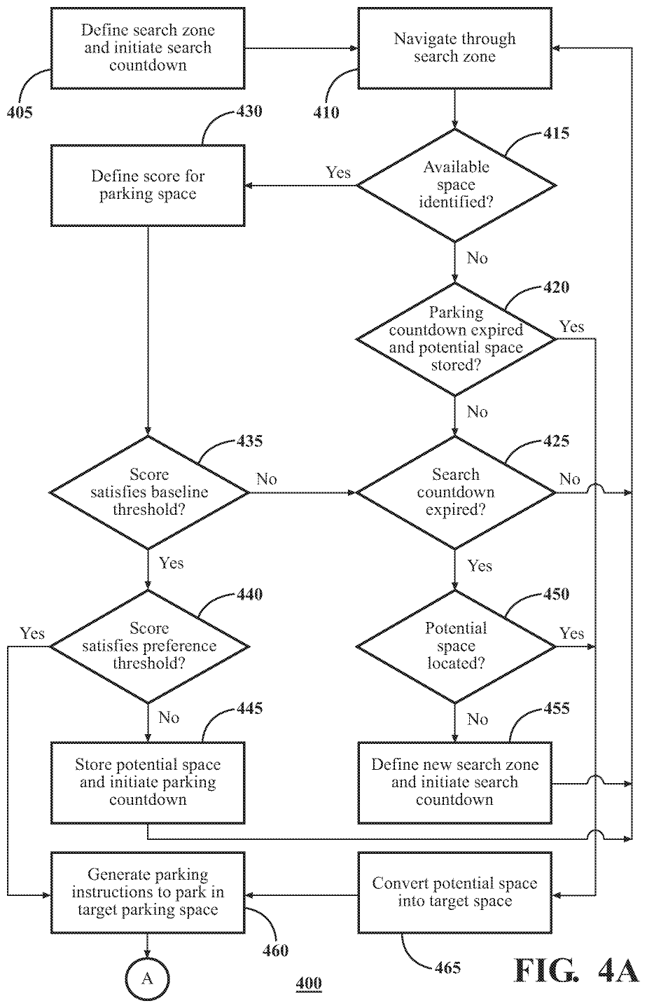

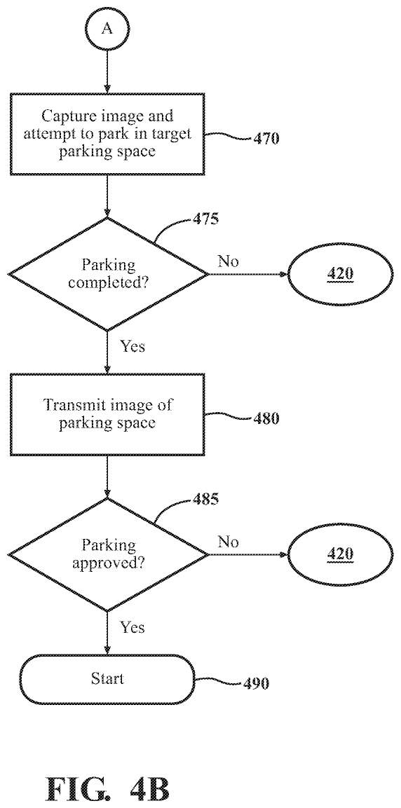

FIGS. 4A and 4B show a flowchart 400 of operations for one or more embodiments of the disclosed vehicle control system 100. It should be clear that the order in which the operations are described is not intended to be construed as a limitation, and any number of the described operations can occur in any order and/or in parallel in actual implementation of the disclosed embodiments. Additionally, any specific reference to one or more operations being capable of being performed in a different order is not to be understood as suggesting that other operations may not be performed in another order.

At operation 405 the drive control module 150 defines a search zone and initiates a search countdown. The drive control module 150 can define the boundaries of the search zone, for example, based on identifying a parking facility in satellite imagery data corresponding to the GPS coordinates of the subject vehicle 200, based on a set range from the subject vehicle 200 (e.g., a 500 meter radius), or based on a set range from a location specified by the user (e.g., a 500 meter radius from the entrance of a store). The search zone can therefore be defined as a selected facility (e.g., a parking garage) or as a shape having boundaries covering a geographic area within which the subject vehicle will remain within while attempting to park. Controlling the search zone ensures that, while searching, the subject vehicle 200 will not travel random and possibly unacceptably large distances from the venue that the user is attending. The user can confirm or adjust the search zone boundaries via the user interface system 195 prior to exiting the subject vehicle 200.

The search countdown determines a length of time that the subject vehicle 200 will remain in the search zone, e.g., fifteen minutes, twenty minutes, etc. As will be seen below, controlling the search countdown reduces a risk of the subject vehicle getting stuck endlessly looping in an area with no available parking. The user can confirm or adjust the search countdown length prior to exiting the subject vehicle 200.

At operation 410 the user exits the subject vehicle 200 and the drive control module 150 navigates the subject vehicle through the search zone. The drive control module 150 can navigate based on, for example, GPS data and/or sensor data used in path-finding algorithms to maneuver through the search zone while avoiding obstacles. In one or more embodiments, the drive control module 150 can determine a route through the search zone such that the subject vehicle passes through the entire zone while attempting to avoid path segments that have already been traversed.

At operation 415 the selection module 130 determines whether an available parking space has been identified, for example, based on data received from the communication system 180 or the sensor system 190. For example, the selection module 130 can analyze available sensor data on an ongoing basis, applying image recognition and machine learning techniques to identify empty parking spaces. When the selection module 130 identifies an empty space, the selection module 130 does not automatically classify an empty parking space as an available parking space but first determines whether any signs, markings or regulatory data indicate that the space is prohibited.

For example, referring back to FIG. 2, the sensor system 190 can capture images of empty parking space 280. The selection module 130 can analyze the captured image and recognize the handicap symbol in the empty parking space 280. Based on this recognition, the selection module 130 will classify empty parking space 280 as a prohibited space and not as an available parking space. Likewise, the selection module 130 can also identify prohibited spaces based on signs near/above parking spaces that read “Reserved”, “Restricted”, “No Parking”, or the like. Furthermore, the selection module 130 can include local regulations regarding other types of restrictions, such as time-based restrictions, parking restrictions based on the color of a curb, parking restrictions related to proximity to fire hydrants, etc.

Referring back to FIG. 4A, at operation 415 if the selection module 130 has not identified an available parking space, the drive control module 150 determines whether a parking countdown (discussed further below) has expired and a potential space has been stored at operation 420. If no parking countdown has expired or no potential space has been stored, the drive control module 150 determines whether the search countdown has expired at operation 425. If the search countdown has not expired, the process cycles back to operation 410, meaning that the subject vehicle 200 will remain in the search zone and continue to search for an available parking space.

Referring back to operation 415, when the selection module 130 does identify an available parking space, the selection module 130 determines a score for the available parking space at operation 430. As discussed above, the selection module 130 can determine the score based on correspondence between attributes of the available parking space and user-defined criteria 170.

At operation 435 the selection module 130 determines whether the score for the available parking space satisfies a baseline threshold. For example, in one or more embodiments the selection module 130 can determine that a score greater than the baseline threshold satisfies the baseline threshold, however, the disclosed subject matter is not limited to this method. Other comparative operators can be used to determine whether the score satisfies the baseline threshold, depending on how determination of the score is implemented. If the score does not satisfy the baseline threshold, i.e., the space does not have attributes to meet the baseline level of acceptance established by the user, the process continues with operation 425. That is, the drive control module 150 determines whether to continue searching in the current search zone based on whether the search countdown has expired.

If the score does satisfy the baseline threshold, the selection module 130 determines whether the score satisfies the preference threshold at operation 440.

When the score for the available parking space satisfies the preference threshold, the selection module 130 classifies the available parking space as a target parking space and the parking module 140 immediately generates parking instructions to cause the subject vehicle to attempt to park in the target parking space at operation 460.

Alternatively, when the score for the available parking space does not satisfy the preference threshold but does satisfy the baseline threshold, the selection module 130 classifies the available parking space as a potential parking space at operation 445. The selection module 130 stores the parking space information 175 (e.g. location, score, attributes) of the potential parking space in the database 160 and the parking module 140 initiates a parking countdown. The process then continues with operation 410, i.e., the drive control module 150 continues to navigate the subject vehicle 200 through the search zone.

The parking countdown represents an amount of time that the subject vehicle 200 risk searching for a higher preferred parking space after a potential parking space has been located. The parking countdown can be shorter than the search countdown, and the user can adjust the length of time of the parking countdown via the user interface system 195 to balance the user's preference between finding a highly desired parking space and taking an acceptable parking space. For example, in one implementation a user may set the parking countdown to two minutes while in another implementation the user may set the parking countdown to zero, causing the subject vehicle to immediately attempt to park in the first potential parking space located.

Accordingly, when the process cycles back to operation 410 after the parking countdown starts, if the subject vehicle 200 does not encounter another available parking space at operation 415, the parking module 140 will check whether the parking countdown has expired at operation 420. If the parking countdown has expired and a potential space is stored in the parking space information 175, then the selection module 130 converts the potential parking space into a target parking space at operation 465.

It is possible that the parking space information 175 stores information for more than one potential parking space (i.e., the subject vehicle 200 has encountered several potential parking spaces). In this case the selection module 130 can determine a conversion order for the potential parking spaces. For example, in one or more embodiments the selection module 130 can convert the potential parking space that has the highest score first. As another example, in one or more embodiments the selection module 130 can convert the closest potential parking space first. In one or more embodiments the user can select an order basis. That is, for example, the user can designate whether the subject vehicle will attempt to park in the nearest potential parking space or the most preferred potential parking space regardless of distance.

After the selection module 130 converts a potential parking space into a target parking space in operation 465, the parking module 140 will immediately generate parking instructions to cause the subject vehicle to attempt to park in the target parking space at operation 465.

Referring to FIG. 4B, when parking instructions have been generated the subject vehicle 200 will capture an image of the target parking space and attempt to park in the target parking space at operation 470. The parking module 140 determines whether the parking attempt was successful at operation 475. If the subject vehicle 200 has successfully parked in the target parking space then the parking module 140 transmits a parking notification to an electronic device associated with the user for approval at operation 480. The parking notification, which can take the form of, for example, a text message or an email, includes the image of the target parking space and requests the user's approval. If the user approves at operation 485, then the process ends at operation 490.

If the user does not approve the parking space or if the parking attempt was not successful, (e.g., another vehicle entered the target space first), the process cycles back to operation 420, i.e., the parking module 140 will immediately check whether a parking countdown has expired and a potential space remains stored to determine whether the subject vehicle should convert a next potential space into a target space. If the parking countdown has expired and the parking space information 175 indicates one or more potential spaces remain stored, then the vehicle control system 100 will repeat the cycle from operation 420 to operation 460, converting each potential parking space into a target parking space and attempting to park in the target parking space until the subject vehicle 200 is successfully parked or no more potential parking spaces remain.

When no potential parking spaces remain, at operation 425 the drive control module checks whether the search countdown has expired. If the search countdown has not expired, the process cycles back to operation 410, i.e., the drive control module 150 resumes autonomously navigating the subject vehicle 200 through the search zone. If the search countdown has expired, the drive control module 150 begins the process of changing the search zone. However, since it is possible that the selection module 130 has recently identified a new potential parking space and triggered a new parking countdown that has not expired, at operation 450 the parking module 140 checks whether any potential parking spaces have been located. The subject vehicle 200 will attempt to park in any stored potential spaces before changing the search zone. When no potential parking spaces remain, the drive control module 150 defines a new search zone at operation 455 and initiates a new search countdown.

The drive control module 150 can define a new search zone in any of various ways. For example, in one or more embodiments the drive control module 150 can expand the boundaries of the search zone (e.g., when the search zone is defined as a shape encompassing a given geographic area, define new coordinates that increase the size and/or configuration of the shape to cover a larger geographic area), augment the search zone with a neighboring parking area (e.g., when the search zone is defined based on a particular parking lot at a mall based on satellite imagery, the augmentation can include adding an additional lot to the search zone), or selecting an entirely different search zone. In selecting a different search zone, the drive control module 150 can select a different parking facility (e.g., a parking garage or parking lot designated by the user) or select a different geographic area (e.g., an area encompassing a neighborhood designated by the user due to knowledge of parking spaces frequently being available there). In one or more embodiments the drive control module 150 can include instructions for a default progression of defining the new search zone, where the progression order can be altered by the user. After the new search zone is defined, the process cycles back to operation 410, i.e., the drive control module 150 begins navigating the subject vehicle 200 through the new search zone.

Accordingly, the disclosed vehicle control system 100 provides a flexible and highly configurable platform for guiding an autonomous or semi-autonomous vehicle in locating a parking space in a wide variety of environments according to user preferences.

Additionally, it should be appreciated that the vehicle control system 100 from FIG. 1 can be configured in various arrangements with separate integrated circuits and/or chips. In such embodiments, the selection module 130 from FIG. 1 can be embodied as a separate integrated circuit. Additionally, the parking module 140 and drive control module 150 can each be embodied on individual integrated circuits. The circuits can be connected via connection paths to provide for communicating signals between the separate circuits. Of course, while separate integrated circuits are discussed, in various embodiments, the circuits may be integrated into a common integrated circuit board. Additionally, the integrated circuits may be combined into fewer integrated circuits or divided into more integrated circuits. In another embodiment, the modules 130, 140 and 150 may be combined into a separate application-specific integrated circuit. In further embodiments, portions of the functionality associated with the modules 130, 140 and 150 may be embodied as firmware executable by a processor and stored in a non-transitory memory. In still further embodiments, the modules 130, 140 and 150 are integrated as hardware components of the processor 110.

In another embodiment, the described methods and/or their equivalents may be implemented with computer-executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies (e.g., shown in flowchart 400 of FIGS. 4A and 4B) are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

The vehicle control system 100 can include one or more processors 110. In one or more arrangements, the processor(s) 110 can be a main processor of the vehicle control system 100. For instance, the processor(s) 110 can be an electronic control unit (ECU). The vehicle control system 100 can include one or more data stores for storing one or more types of data. The data stores can include volatile and/or non-volatile memory. Examples of suitable data stores include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, distributed memories, cloud-based memories, other storage medium that are suitable for storing the disclosed data, or any combination thereof. The data stores can be a component of the processor(s) 110, or the data store can be operatively connected to the processor(s) 110 for use thereby. The term “operatively connected,” as used throughout this description, can include direct or indirect connections, including connections without direct physical contact.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read. In the context of this document, a computer-readable storage medium may be any tangible medium that can contain, or store a program for use by or in connection with an instruction execution system, apparatus, or device.

The following includes definitions of selected terms employed herein. The definitions include various examples and/or forms of components that fall within the scope of a term and that may be used for various implementations. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A vehicle control system for a subject vehicle, comprising:
one or more sensors that output information describing an environment around the subject vehicle;
one or more processors; and
a memory communicably connected to the one or more processors and storing:
a selection module including one or more instructions that, when executed by the one or more processors, cause the one or more processors to:
identify an available parking space and one or more attributes of the available parking space based, at least in part, on the information from the one or more sensors,
classify the available parking space as a target parking space based, at least in part, on the one or more attributes satisfying a preference threshold defined according to one or more user-defined criteria that indicate characteristics of the target parking space, and
a parking module including one or more instructions that, when executed by the one or more processors, cause the one or more processors to generate parking instructions configured to cause the subject vehicle to park in the target parking space.

2. The vehicle control system of claim 1, wherein the selection module identifies the one or more attributes by one or more of: i. retrieving metadata about the available parking space according to a current location of the vehicle, ii. using one or more machine perception components to analyze the information from the one or more sensors and identify signs proximate to the available parking space, characteristics of an environment near the available parking space, and/or markings on a surface of the available parking space, and iii. communicating with a parking facility system to retrieve the one or more attributes.

3. The vehicle control system of claim 1, wherein the one or more attributes indicate one or more of: i. physical characteristics of the available parking space, ii. contextual characteristics of the available parking space, and iii. regulatory characteristics of the available parking space.

4. The vehicle control system of claim 1, wherein the one or more sensors includes a camera, and the parking module further includes instructions to provide a parking notification to an electronic device associated with a user of the subject vehicle, the parking notification requesting approval of the target parking space and including an image of the target parking space captured by the camera.

5. The vehicle control system of claim 1, further comprising a drive control module including one or more instructions that, when executed by the one or more processors, cause the one or more processors to navigate the subject vehicle within a search zone, wherein the selection module identifies the available parking space within the search zone and the drive control module includes instructions to define boundaries of the search zone based on a user setting.

6. The vehicle control system of claim 5, wherein the drive control module further includes instructions to select new coordinates for the search zone when no available parking space is identified within prior coordinates for the search zone after a pre-determined amount of time.

7. The vehicle control system of claim 1, wherein the user-defined criteria defines one or more of:
a preferred type of parking area,
a preferred type of parking space,
a designated object or location to park near,
a designated object or location to avoid parking near,
a maximum parking price amount,
a preferred spacing around a parking space, and
a preferred parking space size.

8. The vehicle control system of claim 7, wherein the user-defined criteria includes a prioritization ranking prioritizing separate ones of the user-defined criteria.

9. The vehicle control system of claim 1, wherein the selection module further includes instructions to determine whether the one or more attributes satisfy the preference threshold by determining whether a score for the available parking space surpasses the preference threshold, and wherein the selection module assigns weight values to the one or more attributes of the available parking space based, at least in part, on correspondence with the user-defined criteria and determines the score for the available parking space as a sum total of the weight values.

10. The vehicle control system of claim 9, wherein the selection module further includes instructions to:
classify the available parking space as a potential parking space when the score does not surpass the preference threshold and does surpass a baseline threshold, and
generate parking instructions configured to cause the subject vehicle to park in the potential parking space when no target parking space is found after a predetermined amount of time.

11. The vehicle control system of claim 1, wherein the selection module further includes instructions to classify the available parking space as a prohibited parking space based, at least in part, on the one or more attributes corresponding to one or more regulatory prohibitions, and to deny the prohibited parking space being classified as the target parking space.

12. A method of improving autonomous parking of a subject vehicle, comprising:
identifying an available parking space and one or more attributes of the available parking space based, at least in part, on information from one or more sensors,
classifying the available parking space as a target parking space based, at least in part, on the one or more attributes satisfying a preference threshold defined according to one or more user-defined criteria that indicate characteristics of the target parking space, and
generating parking instructions configured to cause the subject vehicle to park in the target parking space.

13. The method of claim 12, wherein identifying the one or more attributes comprises one or more of: i. retrieving metadata about the available parking space according to a current location of the vehicle, ii. using one or more machine perception components to analyze the information from the one or more sensors and identify signs proximate to the available parking space, characteristics of an environment near the available parking space, and/or markings on a surface of the available parking space, and iii. communicating with a parking facility system to retrieve the one or more attributes.

14. The method of claim 12, wherein the one or more attributes indicate one or more of: i. physical characteristics of the available parking space, ii. contextual characteristics of the available parking space, and iii. regulatory characteristics of the available parking space.

15. The method of claim 12, further comprising providing a parking notification to an electronic device associated with a user of the subject vehicle, the parking notification requesting approval of the target parking space and including an image of the target parking space.

16. The method of claim 12, further comprising:
defining boundaries of a search zone based on a user setting; and
navigating the subject vehicle autonomously within the search zone, wherein the available parking space is identified within the search zone.

17. The method of claim 16, further comprising selecting new coordinates for the search zone when no available parking space is identified within prior coordinates for the search zone after a pre-determined amount of time.

18. A non-transitory computer-readable medium for controlling a subject vehicle and including instructions that when executed by one or more processors cause the one or more processors to:
identify an available parking space and one or more attributes of the available parking space based, at least in part, on information from one or more sensors,
classify the available parking space as a target parking space based, at least in part, on the one or more attributes satisfying a preference threshold defined according to one or more user-defined criteria that indicate characteristics of the target parking space, and
generate parking instructions configured to cause the subject vehicle to park in the target parking space.

19. The non-transitory computer-readable medium of claim 18, further comprising instructions to:
define boundaries of a search zone based on a user setting; and
navigate the subject vehicle autonomously within the search zone, wherein the available parking space is identified within the search zone.

20. The non-transitory computer-readable medium of claim 19, further comprising instructions to select new coordinates for the search zone when no available parking space is identified within prior coordinates for the search zone after a pre-determined amount of time.
